(19) United States
(12) Patent Application Publication
(10) Pub. No.: US 2006/0082420 A1
(43) Pub. Date: Apr. 20, 2006

(54) Non-reciprocal circuit device

(75) Inventor: Tsuyoshi Kinoshita, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK Corporation, Tokyo (JP)

(21) Appl. No.: 11/245,209

(22) Filed: Oct. 7, 2005

(30) Foreign Application Priority Data
Oct. 8, 2004 (JP) 2004-297004

(51) Int. Cl. H01P 1/32

(52) U.S. Cl. 333/1.1

(57) ABSTRACT

There is provided a non-reciprocal circuit device which is considerably small in size and has excellent mass productivity as compared with a conventional counterpart.

A gyromagnetic component 1, a permanent magnet 2 and yokes 31 and 32 are provided. The permanent magnet 2 is provided on at least one surface side of the gyromagnetic component 1, and applies a direct-current magnetic field to the gyromagnetic component 1. The yokes 31 and 32 form a magnetic path for a magnetic field generated by the permanent magnet 2. At least one side surface of the permanent magnet 2 is exposed to the outside to constitute an external wall surface.

### BACKGROUND OF THE INVENTION

1. Field of the Invention

The present invention relates to a non-reciprocal circuit device such as an isolator or a circulator.

2. Description of the Related Art

A non-reciprocal circuit device such as an isolator or a circulator is used in, e.g., a mobile wireless device such as a mobile phone. This type of non-reciprocal circuit device is configured to accommodate a magnetic component such as a gyromagnetic component constituted of a soft magnetic substrate, a center electrode and others or a permanent magnet, a matching capacitor and an electric component such as a terminating resistance in a magnetic metal case functioning as a yoke as typified by, e.g., Patent References 1 and 2.

A center electrode is combined with a soft magnetic substrate, and a direct-current magnetic field is applied thereto from a permanent magnet. The center electrode includes a plurality of central conductors, and has one end arranged on one surface of the soft magnetic substrate and earthed as a ground portion to a metal case. The central conductors are insulated from each other and arranged so that they cross each other at a predetermined angle on the other surface of the soft magnetic substrate, and an end of each central conductor functions as an external terminal.

A matching capacitor is connected with each of the central conductors. In case of using the non-reciprocal circuit device as an isolator, a terminating resistor is further connected with one central conductor which is not connected with an input/output terminal.

Meanwhile, a reduction in size has been endlessly demanded for this type of non-reciprocal circuit device because of its marketability. As means for responding to a demand for a reduction in size, as disclosed in, e.g., Patent References 1 and 2, there has been proposed a configuration in which a square soft magnetic substrate is used in place of a discoid soft magnetic substrate, this substrate is accommodated in a case having a square inner space and a capacitor or a terminating resistor is accommodated in a very dense state by utilizing a space between the soft magnetic substrate and a case inner wall surface.

However, even if such a configuration as disclosed in Patent References 1 and 2 is adopted, the case has been conventionally considered as an essential constituent part in order to assuredly couple central constituent parts such as a gyromagnetic component or a magnet with each other, and hence there is a limit in a reduction in size.

Patent Reference 1: Japanese Patent application Laid-open No. 1999-205011

Patent Reference 2: Japanese Patent application Laid-open No. 1999-97910

### SUMMARY OF THE INVENTION

It is an object of the present invention to provide a non-reciprocal circuit device, which is considerably small in size as compared with a conventional counterpart, with excellent mass productivity.

To achieve the object, a non-reciprocal circuit device according to the present invention comprises a gyromagnetic component, a permanent magnet and a yoke. The permanent magnet is provided on at least one surface side of the gyromagnetic component, and applies a direct-current magnetic field to the gyromagnetic component. The yoke forms a magnetic path for the magnetic field generated by the permanent magnet.

This configuration is common to the conventional non-reciprocal circuit device. The present invention is characterized in that one side surface of the permanent magnet forms a part of an exterior surface. That is, at least one of both opposing side surfaces of the permanent magnet is exposed to the outside, and serves as a reference surface which determines a widthwise dimension of the entire non-reciprocal circuit device. A case which has been conventionally considered as an essential component is not required for this configuration. According to this configuration, a reduction in size can be realized without being restricted by the case.

Further, a total widthwise dimension between both the opposing side surfaces is determined with one side surface of the permanent magnet being used as a reference, in other words, one of both the opposing side surfaces of the permanent magnet is exposed to the outside. Therefore, for example, it is possible to adopt a process of manufacturing a support portion aggregate in which many support portions are arranged in a lattice-like form, arranging a gyromagnetic component on each of the support portions in this substrate, further superimposing a permanent magnet plate thereon, and then applying cutting processing to take out each non-reciprocal circuit device. Accordingly, mass productivity can be improved, thereby providing a small and inexpensive non-reciprocal circuit device.

Preferably, both the side surfaces of the permanent magnet constitute a part of an external surface, in other words, both the opposing side surfaces of the permanent magnet are exposed on both opposing side surfaces of the non-reciprocal circuit device. In case of this configuration, a widthwise dimension of the permanent magnet determines a widthwise dimension of the entire non-reciprocal circuit device. Since the case which has been conventionally considered as an essential component is not required for this configuration, a reduction in size can be realized without being restricted by the case.

Furthermore, since both the opposing side surfaces of the permanent magnet are exposed on both the opposing side surfaces of the non-reciprocal circuit device, it is possible to adopt a process of manufacturing an aggregate in which many gyromagnetic components are arranged in a lattice-like form to improve efficiency of a manufacturing process of non-reciprocal circuit devices, further superimposing the permanent magnet plate on this aggregate, and applying cutting processing to take out each non-reciprocal circuit device. Therefore, mass productivity can be greatly improved, thereby providing a small and inexpensive non-reciprocal circuit device.

As a concrete conformation, the yoke is led through side surfaces different from both the side surfaces on which side surfaces of the permanent magnet are exposed, i.e., side surfaces in a length direction. In the length direction, an increase in dimension due to a thickness of the yoke must be taken into consideration, but the yoke is formed of a tabular member, which does not result in a serious problem.

Moreover, as a general configuration, the gyromagnetic component includes a soft magnetic substrate and central conductors, and the central conductors are combined with the soft magnetic substrate. Although the soft magnetic substrate constituting the gyromagnetic component is not restricted to a specific shape, a square shape is preferable.

As a further concrete configuration, it is possible to use a structure in which a support substrate is provided and the gyromagnetic component and the permanent magnet are provided on one surface of the support substrate. In this case, the yoke is coupled with the permanent magnet and the support substrate so that the entire structure is constrained. According to this configuration, in a structure having no case, the permanent magnet and the gyromagnetic component can be assuredly constrained in a predetermined positional relationship, thereby obtaining predetermined characteristics.

An outer shape of the gyromagnetic component is preferably smaller than that of the permanent magnet. According to this configuration, when the above-described manufacturing process and cutting process, it is possible to avoid giving a damage to the gyromagnetic component when executing the processes, especially the cutting process.

When an outer shape of the gyromagnetic component is smaller than that of the permanent magnet, there is produced a space due to a difference in outer shape between the gyromagnetic component and the permanent magnet. It is preferable to fill this space with an insulating resin. By doing so, reliability is improved.

As described above, according to the present invention, it is possible to provide a non-reciprocal circuit device, which is considerably small in size as compared with a conventional counter part, with excellent mass productivity.

The present invention will be more fully understood from the detailed description given here in below and the accompanying drawings which are given by way of illustration only, and thus are not to be considered as limiting the present invention.

### BRIEF DESCRIPTION OF THE DRAWINGS

FIG. 1 is an exploded perspective view showing an embodiment of a non-reciprocal circuit device according to the present invention;

FIG. 2 is a perspective view showing an assembling state of the non-reciprocal circuit device depicted in FIG. 1;

FIG. 3 is a perspective view of a gyromagnetic component;

FIG. 4 is an exploded perspective view showing an embodiment of the non-reciprocal circuit device according to the present invention;

FIG. 5 is a perspective view showing an assembling state of the non-reciprocal circuit device depicted in FIG. 4;

FIG. 6 is a perspective view showing a component arrangement;

FIG. 7 is an exploded perspective view showing an embodiment of the non-reciprocal circuit device according to the present invention;

FIG. 8 is a cross-sectional view showing an embodiment of the non-reciprocal circuit device according to the present invention;

FIG. 9 is a cross-sectional view showing another embodiment of the non-reciprocal circuit device according to the present invention;

FIG. 10 is a cross-sectional view showing still another embodiment of the non-reciprocal circuit device according to the present invention;

FIG. 11 is a cross-sectional view showing yet another embodiment of the non-reciprocal circuit device according to the present invention;

FIG. 12 is a cross-sectional view showing a further embodiment of the non-reciprocal circuit device according to the present invention;

FIG. 13 is a cross-sectional view showing a still further embodiment of the non-reciprocal circuit device according to the present invention;

FIG. 14 is a cross-sectional view showing a yet further embodiment of the non-reciprocal circuit device according to the present invention;

FIG. 15 is a cross-sectional view showing another embodiment of the non-reciprocal circuit device according to the present invention;

FIG. 16 is a cross-sectional view showing still another embodiment of the non-reciprocal circuit device according to the present invention;

FIG. 17 is a cross-sectional view showing yet another embodiment of the non-reciprocal circuit device according to the present invention;

FIG. 18 shows a manufacturing method of the non-reciprocal circuit device according to the present invention;

FIG. 19 is a view showing a step following the step depicted in FIG. 18; and

FIG. 20 is a partially enlarged cross-sectional view in the step depicted in FIG. 19.

### DETAILED DESCRIPTION OF THE PREFERRED EMBODIMENTS

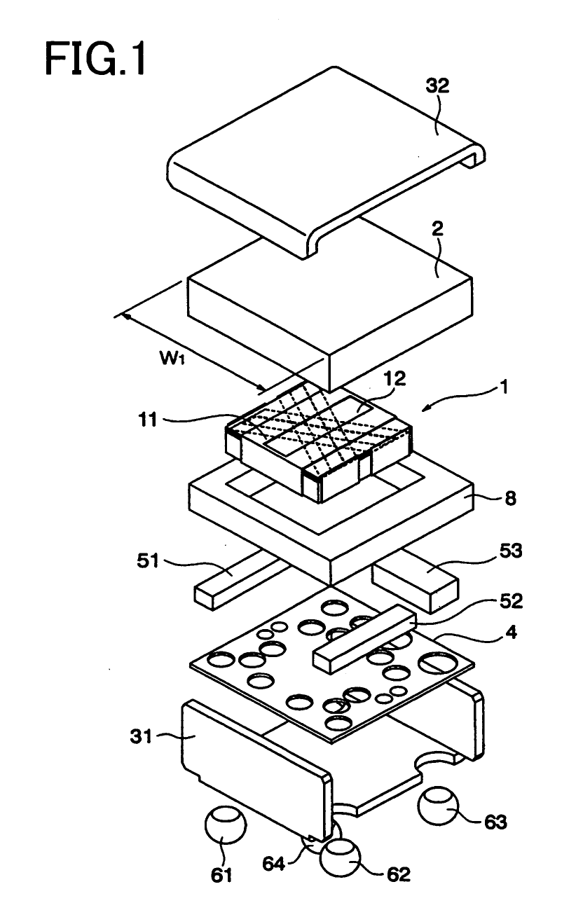

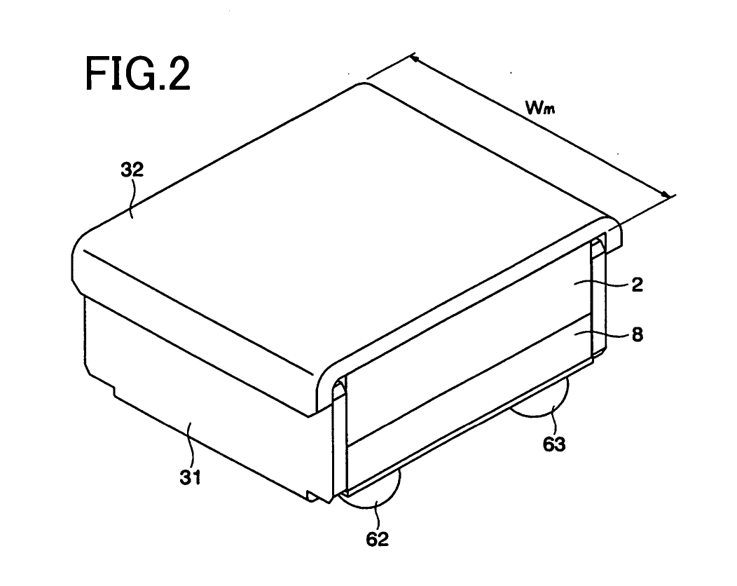

FIGS. 1 to 3 show an example of an isolator. The illustrated non-reciprocal circuit device has a gyromagnetic component 1, a permanent magnet 2, a first yoke 31 and a second yoke 32 as its essential constituent parts. In the embodiment, it further has a support substrate 4, capacitors 51 and 52, a terminating resistor 53 and a plurality of metal balls 61 to 64 which serve as input/output terminals and ground terminals.

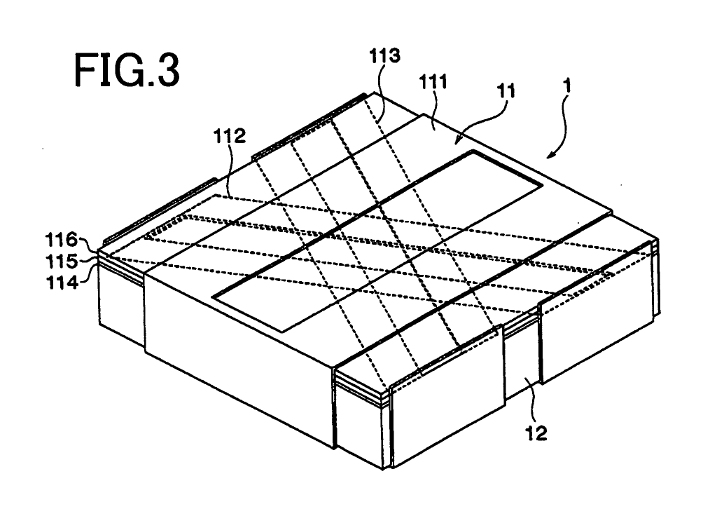

As shown in FIG. 3, the gyromagnetic component 1 includes a center electrode 11 and a soft magnetic substrate 12. The center electrode 11 includes first to third central conductors 111 to 113. In FIG. 3, the first to third central conductors 111 to 113 branch from three sides of a substantially square ground portion which is in contact with a lower surface of the soft magnetic substrate 12. The first to third central conductors 111 to 113 are provided through insulators 115 and 116 in such a manner that they cross each other at a predetermined angle on a main surface of the soft magnetic substrate 12. The third central conductor 113 positioned on the lowermost side is formed on an insulator 114 provided on the soft magnetic substrate 12.

For the soft magnetic substrate 12, a soft magnetic material (ferrite) such as yttrium/iron/garnet (YIG) is preferable. Although the soft magnetic substrate is not restricted to a specific shape, a square shape is preferable.

The permanent magnet 2 applies a direct-current magnetic field to the gyromagnetic component 1, and is provided on one surface side of the gyromagnetic component 1 in the embodiment. However, it may be provided on both surfaces of the gyromagnetic component 1.

The first yoke 31 and the second yoke 32 form a magnetic path for a magnetic field generated by the permanent magnet 2. As a matter of course, each of the first yoke 31 and the second yoke 32 is formed of a magnetic material. Each of the first yoke 31 and the second yoke 32 in the embodiment is obtained by bending a magnetic metal sheet.

In the illustrated embodiment, a total widthwise dimension Wm between both opposing surfaces of the non-reciprocal circuit device on which surfaces of the permanent magnet 2 are exposed is determined based on a widthwise dimension Wt of the permanent magnet 2. That is, both opposing side surfaces of the permanent magnet 2 are exposed on both the opposing side surfaces of the non-reciprocal circuit device to determine the widthwise dimension Wm of the entire non-reciprocal circuit device. A case which has been conventionally considered as an essential component is not required for this configuration. According to this structure, a reduction in size can be realized without being restricted by the case.

Further, the total widthwise dimension Wm between both the opposing side surfaces is determined based on the widthwise dimension Wt of the permanent magnet 2, in other words, both the opposing side surfaces of the permanent magnet 2 are exposed on both the opposing side surfaces of the non-reciprocal circuit device. Therefore, for example, it is possible to adopt a process of manufacturing an aggregate in which many gyromagnetic component elements are arranged in a lattice-like form to increase efficiency of a manufacturing process of the gyromagnetic component elements, superimposing a permanent magnet plate on this aggregate, and applying a cutting process to take out each non-reciprocal circuit device. Accordingly, mass productivity is greatly improved, thereby providing a small and inexpensive non-reciprocal circuit device. This point will be described later in detail.

The first yoke 31 is led through side surfaces different from both the side surfaces on which the side surfaces of the permanent magnet 2 are exposed, i.e., side surfaces in a length direction. In the length direction, although an increase in dimension due to a thickness of the yoke must be taken into consideration, the first yoke 31 can be formed of a tabular member, and hence an increase in thickness by the first yoke 31 does not become a serious problem. Although the first yoke 31 has a shape in which both sides of a bottom plate are raised, it is not necessarily restricted to such a shape.

The second yoke 32 is superimposed on the permanent magnet 2. Furthermore, both ends of the second yoke 32 are coupled with the first yoke 31 to form a magnetic path for a magnetic field generated by the permanent magnet 2. Fixed coupling between the first yoke 31 and the second yoke 32 can be realized by mechanical coupling as well as joining using a solder.

The illustrated non-reciprocal circuit device further includes a support substrate 4, the gyromagnetic component 1 and the permanent magnet 2 are mounted on one surface of the support substrate 4, and the entire structure is constrained by using the first yoke 31 and the second yoke 32. According to this configuration, in the structure having no case, the permanent magnet 2, the gyromagnetic component 1 and the support substrate 4 can be assuredly constrained in a predetermined positional relationship, thereby obtaining predetermined characteristics.

An outer shape of the gyromagnetic component 1 described in the embodiment is smaller than that of the permanent magnet 2. According to this configuration, in a case where the above-described manufacturing process and cutting process are adopted, it is possible to avoid giving a damage to the gyromagnetic component 1 when executing the processes, especially the cutting process.

When the outer shape of the gyromagnetic component 1 is smaller than that of the permanent magnet 2, there occurs a space due to a difference in outer shape between the gyromagnetic component 1 and the permanent magnet 2. It is preferable to fill this space with an insulating resin 8. By doing so, reliability is improved.

Further, in the embodiment, an outer shape of the support substrate 4 is matched with that of the permanent magnet 2. The outer shape of the support substrate 4 is substantially the same as that of the permanent magnet 2 and, when the gyromagnetic component 1 is arranged above the support substrate 4, a space corresponding to a difference in outer shape is generated between an outer periphery of the gyromagnetic component 1 and an outer periphery of the support substrate 4. The capacitors 51 and 52 and the terminating resistor 53 are arranged in the above-described space, secured to a conductor pattern formed on the support substrate 4 by soldering or the like, and further secured to a predetermined one of the central conductors 111 to 113 by means of soldering or the like so that a known circuit configuration can be obtained. Furthermore, the periphery is filled with an insulating resin 8. As shown in FIG. 1, all of the space does not have to be filled, and exposed surfaces alone may be filled with the insulating resin 8.

Moreover, an appropriate electrode is formed on the support substrate 4, and the metal balls 6 which serve as input/output terminals and ground terminals are attached by utilizing the electrode and the conductor pattern. The central conductors 111 to 113, the capacitors 51 and 52 and the terminating resistor 53 are connected with the metal balls 6 so that a predetermined electric circuit can be obtained.

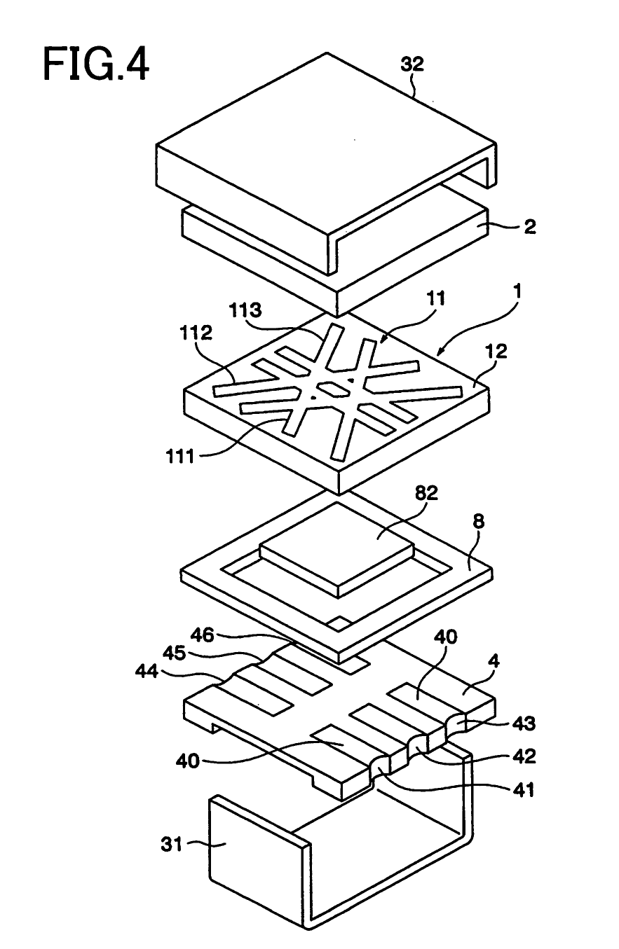

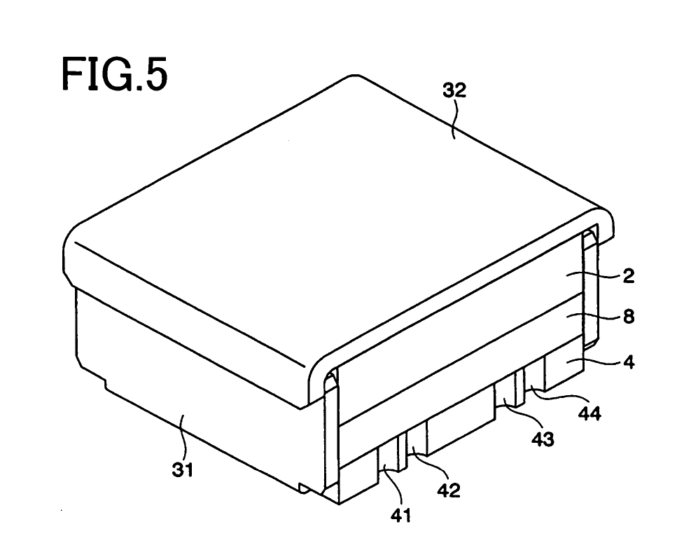

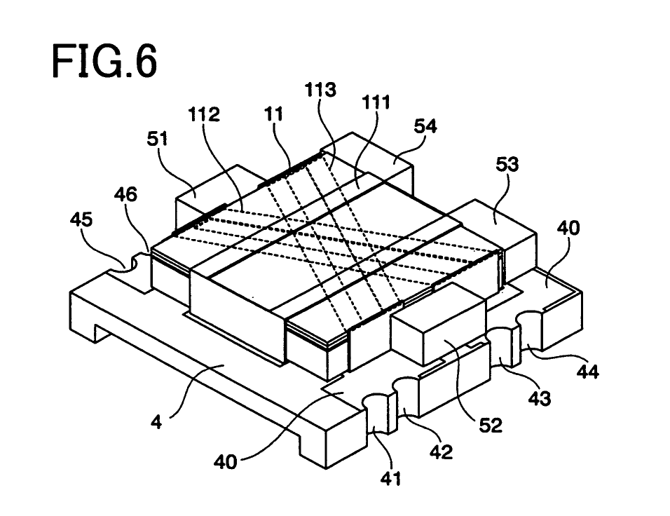

FIGS. 4 to 6 likewise show another example of an isolator. In the drawings, like reference numerals denote parts corresponding to the constituent parts shown in FIGS. 1 to 3, thereby eliminating the tautological explanation. A different from the embodiment shown in FIGS. 1 to 3 lies in a configuration of a support substrate 4. That is, in the embodiment shown in FIGS. 4 to 6, the support substrate 4 has a conductor pattern 40 which is used to connect capacitors 51 and 52, terminating resistors 53 and 53 and central conductors 111 to 113 formed as a predetermined pattern on one surface thereof. Furthermore, concave grooves 41 to 46 or the like are provided on side surfaces of the support substrate 4, and a conductor film which is continuous with the conductor pattern 40 is given in each of the concave grooves 41 to 46. Of the concave grooves 41 to 46, for example, the concave grooves 41 and 42 are used as input terminals, the concave grooves 43 and 44 are used as ground terminals, and the concave grooves 45 and 46 are used as output terminals.

In this embodiment, a total widthwise dimension Wm between both opposing side surfaces is likewise determined based on a widthwise dimension Wt of a permanent magnet 2. That is, a case which has been conventionally considered as an essential component is not provided. Therefore, this embodiment demonstrates the same function and effect as those of the embodiment shown in FIGS. 1 to 3.

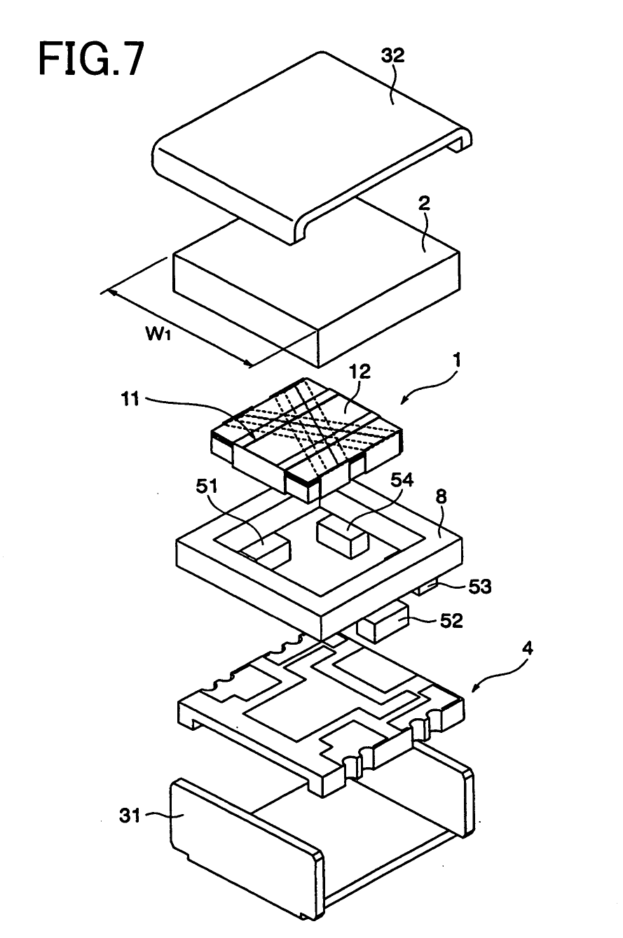

FIG. 7 is an exploded perspective view showing an embodiment of the non-reciprocal circuit device according to the present invention. In the drawing, like reference numerals denote parts corresponding to the constituent parts depicted in FIGS. 1 to 6, thereby eliminating the tautological explanation. The embodiment shown in FIG. 7 is characterized in a configuration of a gyromagnetic component 1. That is, the gyromagnetic component 1 has a configuration in which a center electrode 11 is formed as a conductor film on one surface of a soft magnetic substrate 12. Central conductors 111 to 113 constituting the center electrode 11 are insulated from each other through inorganic or organic insulating films and formed on one surface of the soft magnetic substrate 12. When leading out the central conductors 111 to 113, a through hole technique or the like can be applied.

Moreover, an outer shape of the gyromagnetic component 1 is substantially the same as that of a permanent magnet 2. Furthermore, a plane outer shape of the support substrate 4 is substantially the same as those of the gyromagnetic component 1 and the permanent magnet 2. When such a configuration is adopted, after a process of manufacturing an aggregate in which many gyromagnetic component elements are arranged in a lattice-like form, superimposing a permanent magnet plate on this aggregate and applying cutting processing to this structure to then take out each non-reciprocal circuit device, it is possible to take out each assembly consisting of the support substrate 4, the gyromagnetic component 1 and the permanent magnet 2.

The gyromagnetic component is joined to the support substrate 4 through a functional substrate 82 including capacitors and a terminating resistor required in a circuit configuration. In this case, as described above, it is good enough to fill a space with an insulating resin 8. It is not necessary to fill the entire space, and filling exposed surfaces alone with the insulating resin 8 can suffice. Further, a bonding function may be provided to the above-described insulating resin 8. In this case, it is possible to improve securing strength between constituent components, e.g., the permanent magnet 2, the support substrate 4 and the gyromagnetic component 1.

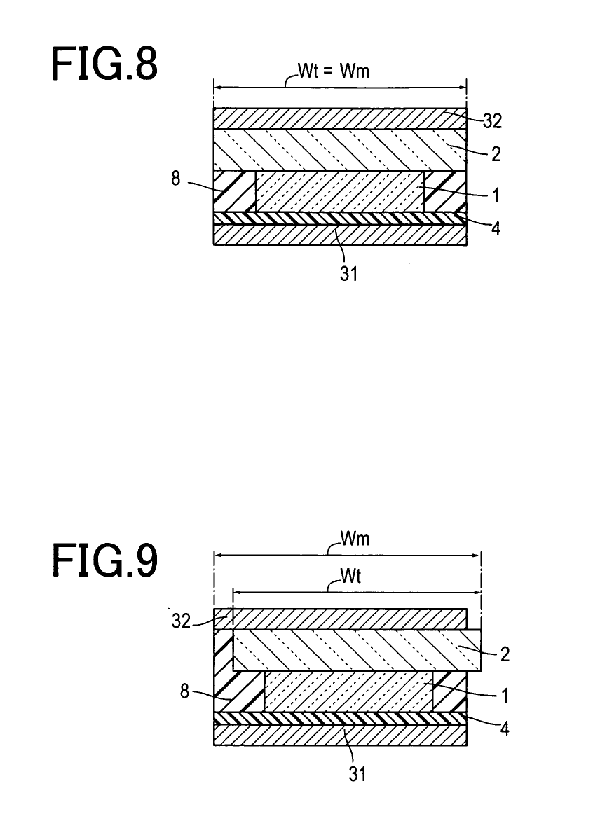

Meanwhile, the non-reciprocal circuit device according to the present invention does not have a configuration constrained by the case, and the respective components, e.g., the gyromagnetic component 1, the permanent magnet 2, the first yoke 31, the second yoke 32, the support substrate 4 and others are combined with each other. Therefore, assembling positions of the respective constituent components are displaced. Moreover, irregularities in shape of the respective constituent components are deservingly expected. Of course, basically, the side surfaces of the permanent magnet 2 are utilized as a part of an exterior surface, but a completed product may take a different conformation depending on the above-described assembling position displacement and relative differences in shape of the constituent components in some cases. Some of concrete examples of such a conformation are shown in FIGS. 8 to 17.

First, in an example of FIG. 8, both side surfaces of a permanent magnet 2 are exposed to the outside to constitute a part of an exterior surface, and a widthwise dimension Wt between both the side surfaces of the permanent magnet 2 determines a total widthwise dimension Wm of a non-reciprocal circuit device. Both side surfaces of each of a first yoke 31, a second yoke 32 and a support substrate 4 are also placed at the same position as both the side surfaces of the permanent magnet 2 to constitute the exterior surface. A gyromagnetic component 1 has a narrower width (a smaller area) than those of the permanent magnet 2 and the support substrate 4, and a space generated due to a difference in width (a difference in area) is filled with an adhesive resin 8. The example shown in FIG. 8 corresponds to an example in which the non-reciprocal circuit device corresponding to the embodiments shown in FIGS. 1 to 6 is realized without producing displacement or the like.

Next, FIG. 9 shows an example in which a permanent magnet 2 is displaced from the normal position depicted in FIG. 8 and protrudes toward one lateral surface side. One protruding side surface of the permanent magnet 2 is an exterior surface. Further, a total widthwise dimension Wm of a non-reciprocal circuit device is a dimension obtained by adding an amount corresponding to the displacement to a widthwise dimension Wt between both side surfaces of the permanent magnet 2.

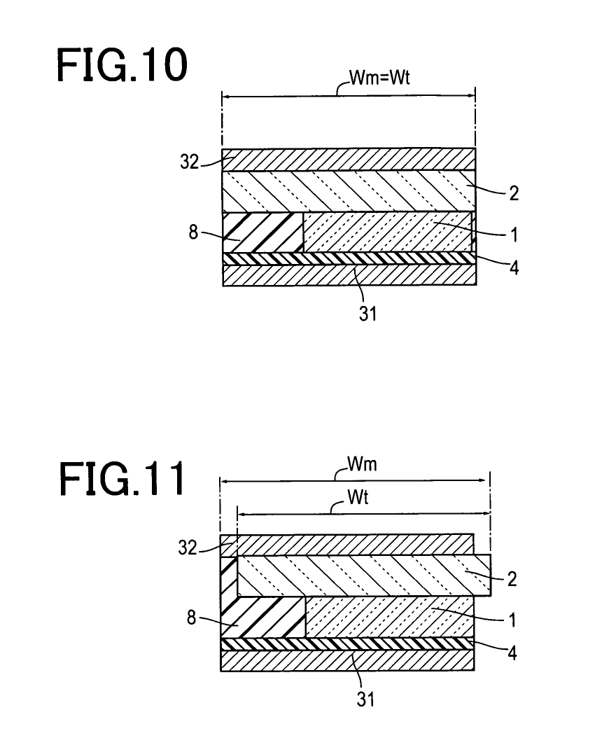

FIG. 10 shows an example in which a gyromagnetic component 1 is displaced from the position depicted in FIG. 8. In this case, both side surfaces of a permanent magnet 2 constitute an exterior surface. Furthermore, since the permanent magnet 2 is not displaced, a widthwise dimension Wt between both side surfaces of the permanent magnet 2 determines a total widthwise dimension Wm of a non-reciprocal circuit device.

FIG. 11 shows an example in which a gyromagnetic component 1 and a permanent magnet 2 are displaced from the position depicted in FIG. 8. In this case, one protruding side surface of the permanent magnet 2 and a side surface of the gyromagnetic component 1 constitute an exterior surface. Moreover, a total widthwise dimension Wm of a non-reciprocal circuit device is a dimension obtained by adding an amount corresponding to the displacement to a widthwise dimension Wt between both side surfaces of the permanent magnet 2.

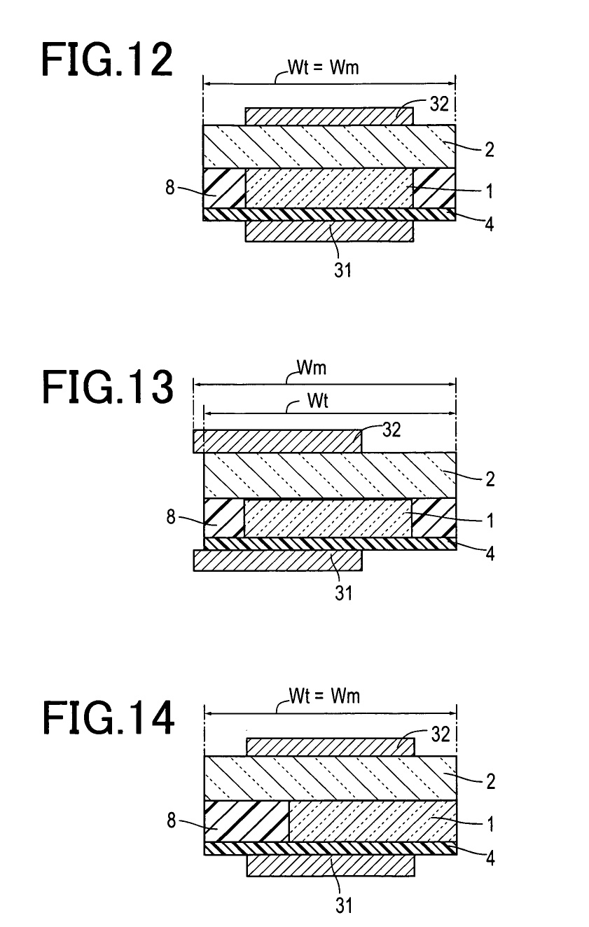

FIG. 12 corresponds to an example in which a width of each of a first yoke 31 and a second yoke 32 is narrower than a widthwise dimension Wt of a permanent magnet 2, and shows an ideal assembling state in which no displacement is produced between constituent components. In this case, both side surfaces of the permanent magnet 2 are likewise exposed to the outside to constitute a part of an exterior surface.

Next, FIG. 13 shows an example in which each of a first yoke 31 and a second yoke 32 is displaced from the normal position depicted in FIG. 12. Both side surfaces of a permanent magnet 2 are exposed to the outside to constitute a part of an exterior surface. A total widthwise dimension Wm of a non-reciprocal circuit device is a dimension obtained by adding an amount corresponding to protrusion involved by the displacement of each of the first yoke 31 and the second yoke 32 to a widthwise dimension Wt between both side surfaces of the permanent magnet 2.

FIG. 14 shows an example in which a gyromagnetic component 1 is displaced from the position depicted in FIG. 12. In this case, one side surface of a permanent magnet 2 is exposed to the outside to constitute a part of an exterior surface. Since a relative position of each of a first yoke 31 and a second yoke 32 with respect to the permanent magnet 2 remains unchanged, a widthwise dimension Wt between both side surfaces of the permanent magnet 2 determines a total widthwise dimension Wm of a non-reciprocal circuit device.

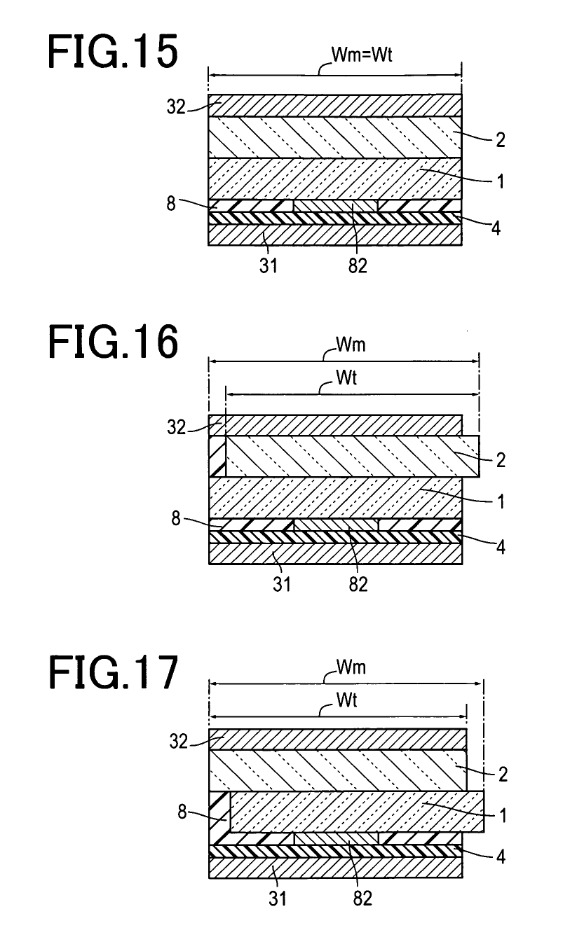

In an example of FIG. 15, both side surfaces of each of a first yoke 31, a second yoke 32, a support substrate 4 and a gyromagnetic component 1 are placed at the same position as that of both side surfaces of a permanent magnet 2 to constitute an exterior surface. A periphery of a functional substrate 82 provided between the gyromagnetic component 1 and the support substrate 4 is filled with an adhesive resin 8. The embodiment shown in FIG. 9 substantially corresponds to the embodiment depicted in FIG. 7.

FIG. 16 shows an example in which a permanent magnet 2 is displaced from the ideal state illustrated in FIG. 15 and thereby protrudes toward one lateral surface side. In this example, one side surface of the permanent magnet 2 is exposed to the outside to constitute a part of an exterior surface. A total widthwise dimension Wm of a non-reciprocal circuit device is a dimension obtained by adding an amount corresponding to the displacement to a widthwise dimension Wt between both side surfaces of the permanent magnet 2.

FIG. 17 shows an example in which a gyromagnetic component 1 and a support substrate 4 are displaced from the ideal state depicted in FIG. 15. In this example, both side surfaces of a permanent magnet 2 are exposed to the outside to constitute a part of an exterior surface. Since a relative position of each of a first yoke 31 and a second yoke 32 with respect to the permanent magnet 2 remains unchanged, a widthwise dimension Wt between both the side surface of the permanent magnet 2 determines a total width wise dimension Wm of a non-reciprocal circuit device.

Although not shown, there are different displacement conformations, and a total widthwise dimension Wm of a non-reciprocal circuit device thereby becomes different in some cases.

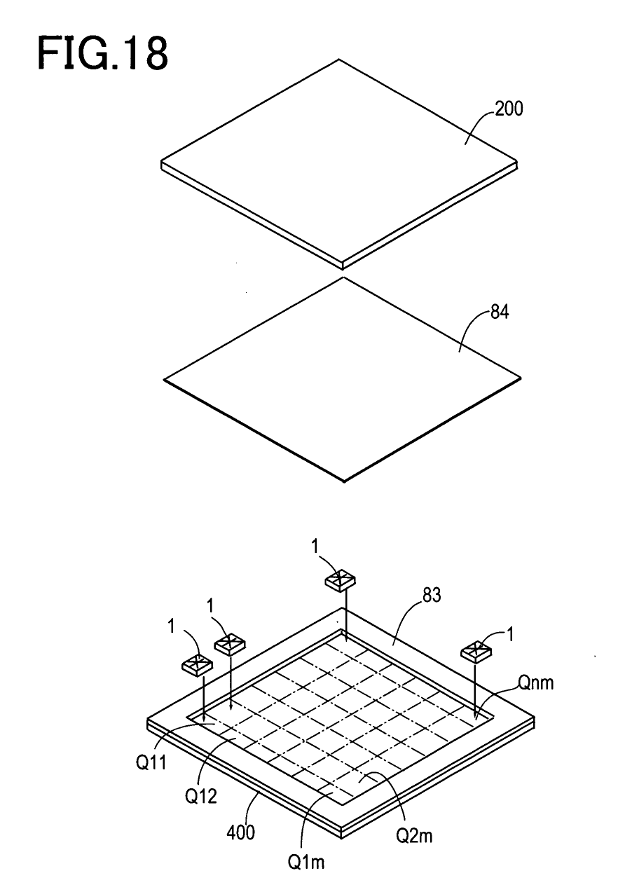

FIGS. 18 to 20 show a manufacturing method of the non-reciprocal circuit device according to the present invention. In case of manufacturing the non-reciprocal circuit device depicted in FIGS. 1 to 6, first, as shown in FIG. 18, a support substrate 400 in which many support portions Q11 to Qnm are arranged in a lattice-like form is produced, and a previously manufactured gyromagnetic component 1 is bonded to each of the support portions Q11 to Qnm. Capacitors 51 and 52 and a terminating resistor 53 (54) (see FIGS. 1 to 6) are attached together with the gyromagnetic component 1. It is good enough to provide a frame portion 83 on an outer rim of the support substrate 400 in order to prevent an injected resin from leaking.

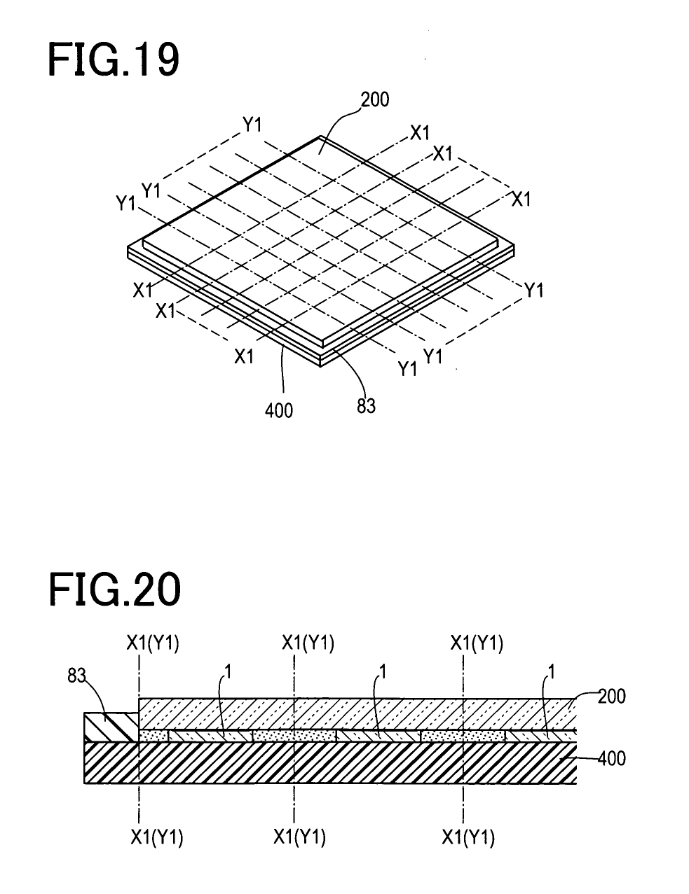

Then, an insulating resin 8 is injected around the gyromagnetic component 1 on the support substrate 400, and a permanent magnet plate 200 is bonded by using an insulating adhesive layer 84. When the insulating resin 8 is provided with an adhesion function, a permanent magnet 200 can be bonded without using the insulating adhesive layer 84. As a result, an assembly shown in FIGS. 19 and 20 can be obtained.

Then, as shown in FIGS. 19 and 20, the entire structure is cut along cutting lines X1-X1 and Y1-Y1 in accordance with each gyromagnetic component 1. As a result, in the non-reciprocal circuit device depicted in FIGS. 1 to 6, each assembly including the support substrate 4, the gyromagnetic component 1 and the permanent magnet 2 can be obtained at a stroke. Thereafter, the non-reciprocal circuit device shown in FIGS. 1 to 6 can be obtained by attaching a first yoke 31 and a second yoke 32.

In case of manufacturing the non-reciprocal circuit device depicted in FIG. 7, an aggregate having gyromagnetic components arranged in a lattice-like form therein is superimposed and bonded on a support substrate 400 in FIG. 18, a permanent magnet plate is further superimposed and bonded thereon, and then cutting processing shown in FIGS. 19 and 20 is carried out.

As described above, in the non-reciprocal circuit device according to the present invention, since it is possible to adopt a process of manufacturing the necessary aggregate to improve efficiency of a manufacturing process of the non-reciprocal circuit devices and further applying cutting processing to this aggregate to take out each non-reciprocal circuit device, mass productivity can be greatly improved, thereby providing a small and inexpensive non-reciprocal circuit device.

While the present invention has been particularly shown and described with reference to preferred embodiments thereof, it will be understood by those skilled in the art that various changes in form and detail may be made therein without departing from the spirit, scope and teaching of the invention.

What is claimed is:

1. A non-reciprocal circuit device comprising: a gyromagnetic component; a permanent magnet; and a yoke,
wherein the permanent magnet is provided on at least one surface side of the gyromagnetic component and applies a direct-current magnetic field to the gyromagnetic component,
the yoke forms a magnetic path for a magnetic field generated by the permanent magnet, and
at least one side surface of the permanent magnet constitutes a part of an exterior surface.

2. The non-reciprocal circuit device according to claim 1, wherein both side surfaces of the permanent magnet constitute a part of the exterior surface.

3. The non-reciprocal circuit device according to claim 1, wherein the yoke is led through side surfaces different from both the side surfaces.

4. The non-reciprocal circuit device according to claim 2, wherein the yoke is led through side surfaces different from both the side surfaces.

5. The non-reciprocal circuit device according to claim 1, wherein the gyromagnetic component comprises a soft magnetic substrate and central conductors, and the central conductors are combined with the soft magnetic substrate.

6. The non-reciprocal circuit device according to claim 2, wherein the gyromagnetic component comprises a soft magnetic substrate and central conductors, and the central conductors are combined with the soft magnetic substrate.

7. The non-reciprocal circuit device according to claim 3, wherein the gyromagnetic component comprises a soft magnetic substrate and central conductors, and the central conductors are combined with the soft magnetic substrate.

8. The non-reciprocal circuit device according to claim 1, further comprising a support substrate,
wherein the gyromagnetic component and the permanent magnet are mounted on one surface of the support substrate, and
the yoke is coupled with the permanent magnet and the support substrate to constrain the entire structure.

9. The non-reciprocal circuit device according to claim 2, further comprising a support substrate,
wherein the gyromagnetic component and the permanent magnet are mounted on one surface of the support substrate, and
the yoke is coupled with the permanent magnet and the support substrate to constrain the entire structure.

10. The non-reciprocal circuit device according to claim 3, further comprising a support substrate,
wherein the gyromagnetic component and the permanent magnet are mounted on one surface of the support substrate, and
the yoke is coupled with the permanent magnet and the support substrate to constrain the entire structure.

11. The non-reciprocal circuit device according to claim 4, further comprising a support substrate,
wherein the gyromagnetic component and the permanent magnet are mounted on one surface of the support substrate, and
the yoke is coupled with the permanent magnet and the support substrate to constrain the entire structure.

12. The non-reciprocal circuit device according to claim 1, wherein an outer shape of the gyromagnetic component is smaller than that of the permanent magnet, and a space generated due to the difference in outer shape between the gyromagnetic component and the permanent magnet is filled with an insulating resin.

13. The non-reciprocal circuit device according to claim 2, wherein an outer shape of the gyromagnetic component is smaller than that of the permanent magnet, and a space generated due to the difference in outer shape between the gyromagnetic component and the permanent magnet is filled with an insulating resin.

14. The non-reciprocal circuit device according to claim 3, wherein an outer shape of the gyromagnetic component is smaller than that of the permanent magnet, and a space generated due to the difference in outer shape between the gyromagnetic component and the permanent magnet is filled with an insulating resin.

15. The non-reciprocal circuit device according to claim 4, wherein an outer shape of the gyromagnetic component is smaller than that of the permanent magnet, and a space generated due to the difference in outer shape between the gyromagnetic component and the permanent magnet is filled with an insulating resin.

16. The non-reciprocal circuit device according to claim 5, wherein an outer shape of the gyromagnetic component is smaller than that of the permanent magnet, and a space generated due to the difference in outer shape between the gyromagnetic component and the permanent magnet is filled with an insulating resin.

17. The non-reciprocal circuit device according to claim 6, wherein an outer shape of the gyromagnetic component is smaller than that of the permanent magnet, and a space generated due to the difference in outer shape between the gyromagnetic component and the permanent magnet is filled with an insulating resin.

18. The non-reciprocal circuit device according to claim 7, wherein an outer shape of the gyromagnetic component is smaller than that of the permanent magnet, and a space generated due to the difference in outer shape between the gyromagnetic component and the permanent magnet is filled with an insulating resin.

19. The non-reciprocal circuit device according to claim 8, wherein an outer shape of the gyromagnetic component is smaller than that of the permanent magnet, and a space generated due to the difference in outer shape between the gyromagnetic component and the permanent magnet is filled with an insulating resin.

20. The non-reciprocal circuit device according to claim 9, wherein an outer shape of the gyromagnetic component is smaller than that of the permanent magnet, and a space generated due to the difference in outer shape between the gyromagnetic component and the permanent magnet is filled with an insulating resin.
